(19) United States
(12) Patent Application Publication
(10) Pub. No.: US 2017/0308077 A1
(43) Pub. Date: Oct. 26, 2017

(54) CONTROLLER FOR AN UNMANNED AERIAL VEHICLE

(71) Applicant: Uvionix Aerospace Corporation, Rancho Cordova, CA (US)

(72) Inventors: Yordan Iskrev, Rancho Cordova, CA (US); Boris Iskrev, Rancho Cordova, CA (US)

(73) Assignee: Uvionix Aerospace Corporation, Rancho Cordova, CA (US)

(21) Appl. No.: 15/494,811

(22) Filed: Apr. 24, 2017

Related U.S. Application Data
(60) Provisional application No. 62/327,025, filed on Apr. 25, 2016.

(51) Int. Cl. G05D 1/00; B64C 39/02; B64D 45/00

(52) U.S. Cl. CPC G05D 1/0016; G05D 1/0088; G05D 1/0022; B64C 39/024; B64D 45/00; B64C 2201/146; B64D 2045/0085

(57) ABSTRACT

A controller for an unmanned aerial vehicle includes a frame having a pair of opposed arms configured to removably receive a smart device therebetween, at least one point stick module positioned on at least one of the arms, and a control unit configured to establish and maintain a connection with the smart device. The at least one point stick module is operable by a user to control movement of the unmanned aerial vehicle.

### CROSS-REFERENCE TO RELATED APPLICATIONS

This application claims the benefit of U.S. Provisional Application Ser. No. 62/327,025, filed on Apr. 25, 2016, which is hereby incorporated by reference herein in its entirety.

### FIELD OF THE INVENTION

The present invention relates generally to aerial vehicles and, more particularly, to a controller for an unmanned aerial vehicle.

### BACKGROUND OF THE INVENTION

An unmanned aerial vehicle (UAV), commonly known as a drone, is an aircraft without a human pilot aboard. Its flight is controlled either autonomously by onboard computers or by the remote control of a pilot on the ground or in another vehicle. UAVs are commonly used in military and special operations applications, and are increasingly finding uses in civil, commercial and recreational applications, such as policing and surveillance, aerial filming, and delivering of packages to end consumers.

As is known in the art, UAV controllers are typically utilized for interactively controlling the motion of the UAV. While generally suitable for what is regarded as ordinary performance, existing controllers are often cumbersome and difficult to handle. In particular, existing controllers are often heavy, have a center of mass that makes it difficult for an operator to handle the device, and/or have poor viewing angles particularly when a user interacts with the controls.

In view of the above, there is therefore a need for a UAV controller that is ergonomic and which presents an optimal viewing angle, particularly when the controls are manipulated by an operator.

### SUMMARY OF THE INVENTION

It is an object of the present invention to provide a controller for an unmanned aerial vehicle.

It is another object of the present invention to provide a controller for an unmanned aerial vehicle that is lightweight.

It is another object of the present invention to provide a controller for an unmanned aerial vehicle that is ergonomic.

It is another object of the present invention to provide a controller for an unmanned aerial vehicle that has an optimal center of mass.

It is another object of the present invention to provide a controller for an unmanned aerial vehicle that allows for convenient user interaction with the controls.

These and other objects are achieved by the present invention.

According to an embodiment of the present invention, a controller for an unmanned aerial vehicle includes a frame having a pair of opposed arms configured to removably receive a smart device therebetween, at least one point stick module positioned on at least one of the arms, and a control unit configured to establish and maintain a connection with the smart device. The at least one point stick module is operable by a user to control movement of the unmanned aerial vehicle.

According to another embodiment of the present invention, a method for controlling an unmanned aerial vehicle includes establishing a first data connection between an unmanned aerial vehicle and a smart device, establishing a second data connection between the smart device and a controller device, receiving a plurality of commands from a user interface of the controller device, and forwarding the plurality of commands from the user interface to the unmanned aerial vehicle for execution.

According to yet another embodiment of the present invention, a system for controlling an unmanned aerial vehicle includes a smart device, a controller having a frame having and a pair of opposed arms defining a receiving space therebetween, and at least one point stick module positioned on at least one of the arms, the receiving space being configured to receive the smart device therein, and an unmanned aerial vehicle. The smart device is configured to establish and maintain a first data connection between the unmanned aerial vehicle and a smart device. The controller is configured to establish and maintain a second data connection between the smart device and a controller. The smart device is configured to forward commands from the point stick modules to the unmanned aerial vehicle for execution.

### BRIEF DESCRIPTION OF THE DRAWINGS

The present invention will be better understood from reading the following description of non-limiting embodiments, with reference to the attached drawings, wherein below:

FIG. 1 is a perspective view of a controller for an unmanned aerial vehicle, according to an embodiment of the present invention.

FIG. 2 is a front elevational view of the controller of FIG. 1.

FIG. 3 is a top plan view of the controller of FIG. 1.

FIG. 4 is a left side elevational view of the controller of FIG. 1.

FIG. 5 is a rear elevational view of the controller of FIG. 1.

FIG. 6 is a perspective view of the controller of FIG. 1, shown coupled to a tablet.

FIG. 7 is a perspective view of a controller for an unmanned aerial vehicle, according to another embodiment of the present invention.

FIG. 8 is a front elevational view of the controller of FIG. 7.

FIG. 9 is a top plan view of the controller of FIG. 7.

FIG. 10 is a left side elevational view of the controller of FIG. 7.

FIG. 11 is a rear elevational view of the controller of FIG. 7.

FIG. 12 is a perspective view of the controller of FIG. 7, shown coupled to a tablet.

FIG. 13 is a schematic illustration of a system for controlling an unmanned aerial vehicle utilizing the controller of FIG. 1, according to an embodiment of the invention.

### DETAILED DESCRIPTION OF THE PREFERRED EMBODIMENT

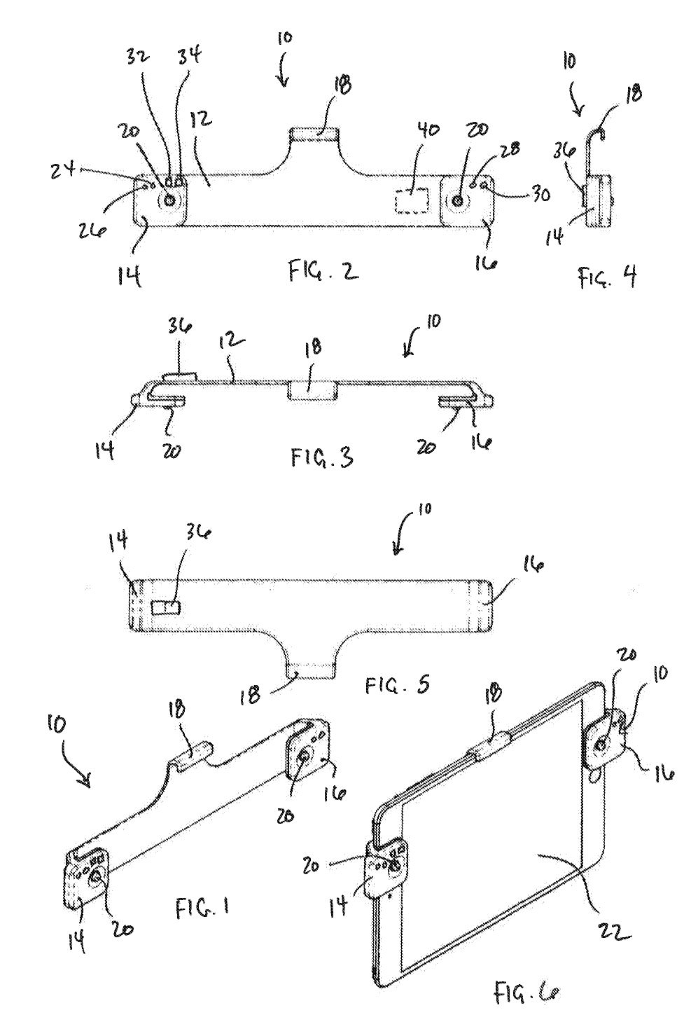

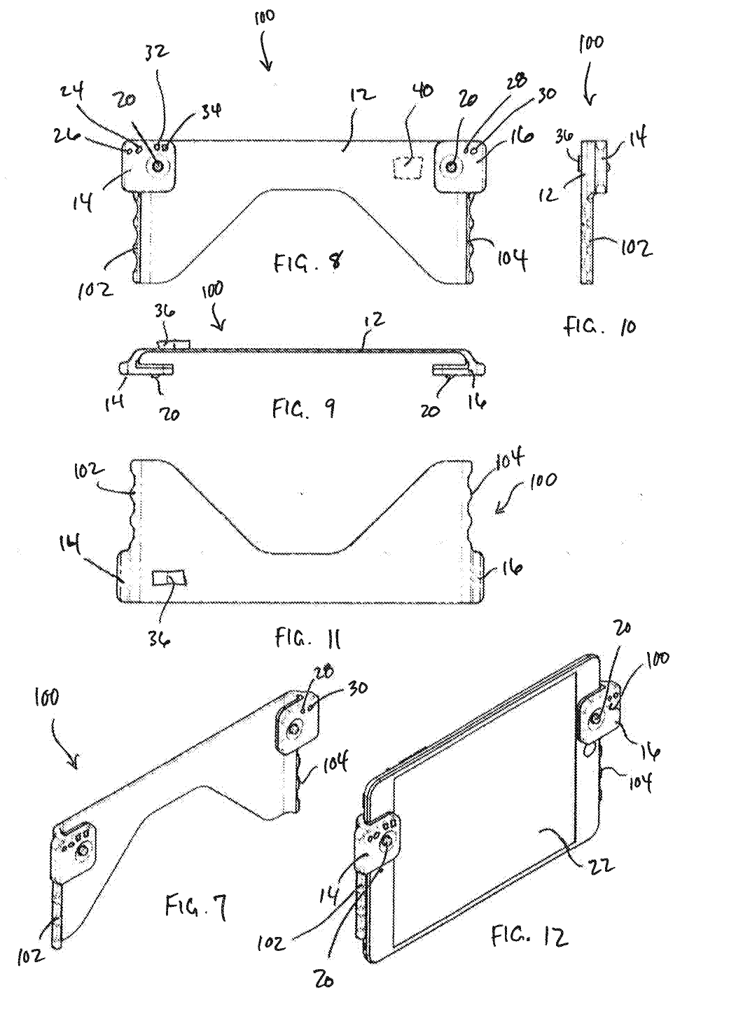

With reference to FIGS. 1-6, a controller 10 for an unmanned aerial vehicle is illustrated. While the present invention is described in reference to an unmanned aerial vehicle, it should be appreciated that the present invention may also be utilized to control other vehicles and machinery, more generally.

As shown therein, the controller 10 includes a frame 12 having a pair of opposed arms 14, 16 configured to receive opposed top and bottom edges of a smartphone, tablet laptop computer or other electronic device 22, and a transverse arm 18 configured to receive a side edge of the smartphone or tablet. In an embodiment, the length of the arms 14, 16, 18 may be adjustable so as to accommodate various smartphones and/or tablets that are different in size. In other embodiments, the frame 12 may be manufactured to specifically accommodate various specific models of smartphones, laptop computers and/or tablets.

As further shown in FIGS. 1-6, the controller 10 further includes a pair of opposed pointing/point stick modules 20 located on the distal ends of the arms 14, 16. As used herein, “pointing stick module” or “point stick module” means a joystick-like electro-mechanic module (typically used for computer-mouse alternatives/input human-interface device), of either one of the following types: (a) where two or more strain gauges are used to measure the force applied by a user and determine X and Y offset of the desired motion (e.g., Sprintek SK7102 pointing stick mouse encoder), or (b) where the user moves with his/her finger a tiny magnet and a hall-effect based integrated circuit is used to determine the X and Y displacement of the magnet (e.g., Austrian Micro Systems EasyPoint joystick and system), which are proportional to the desired motion X and Y offsets

As illustrated therein, and most clearly in FIG. 6, the pointing stick modules 20 are positioned on or adjacent to the lateral sides of a smartphone/tablet 20, when attached to the controller 10 in a way that the “stick” of at least one pointing stick module 20 is positioned below or close to the thumb of the user, when holding the smartphone/tablet in “landscape” or “portrait” orientation, in order the user to be capable of simultaneously holding the smartphone/tablet 22 and operating the pointing sticks.

In the preferred embodiment, the plane of force application (left-right and front-back) of the pointing sticks is parallel or at an angle to the plane of the screen of the smartphone/tablet.

In an embodiment, the UAV controller 10 can be designed as a one solid device, in which case, every controller will be specially designed to fit a particular brand/model of smartphone/tablet. In other embodiments, the controller can be designed as two solid pieces, joined by a flexible/adjustable link—in which case the controller can be used for a number of smartphones/tablets of varying sizes and configurations.

In an embodiment, the power supply for the controller 10 is provided either by a built-in battery (rechargeable or replaceable) or via wired or wireless energy transfer from the battery of the smartphone/tablet.

In an embodiment, the point stick module 20 on the left arm 14 is configured to control the altitude/heading of the UAV with which the controller 10 is design to interface, while the point stick module on the right arm 16 is configured to control the attitude of the UAV. For example, in operation, when the user applies vertical upward force on the attitude control stick, this command will have the meaning of “nose down” change of the attitude of the UAV, with the setpoint angle of the attitude (with respect to a water level attitude) proportional to the intensity of the force exerted by the user on the point stick module. Alternatively, when the user applies vertical downward force on the attitude control stick this command will have the meaning of “nose up” change of the attitude of the UAV, with the setpoint angle of the attitude (with respect to a water level attitude) proportional to the intensity of the force exerted by the user on the point stick module. Moreover, when the user applies horizontal left force on the attitude control stick, this command will have the meaning of “bank left” change of the attitude of the UAV, with the setpoint angle of the attitude (with respect to a water level attitude) proportional to the intensity of the force exerted by the user on the point stick module. Conversely, when the user applies horizontal right force on the attitude control stick this command will have the meaning of “bank right” change of the attitude of the UAV, with the setpoint angle of the attitude (with respect to a water level attitude) proportional to the intensity of the force exerted by the user on the point stick module. In an embodiment, any combination of commands, e.g. left and up, or down and right, etc. will be supported. In an embodiment, a released attitude control stick will have the meaning of “water level attitude.”

Further to the above, in operation, when the user applies vertical upward force on the altitude/heading control stick this command will have the meaning of “ascend” change of the altitude of the UAV, with the setpoint of the upward vertical velocity of the UAV proportional to the intensity of the force exerted by the user on the point stick module. When the user applies vertical downward force on the altitude/heading control stick this command will have the meaning of “descend” change of the altitude of the UAV, with the setpoint of the downward vertical velocity of the UAV proportional to the intensity of the force exerted by the user on the point stick module. In an embodiment, zero vertical force applied on the stick will have the meaning of “hold current position”. Moreover, when the user applies horizontal left force on the altitude/heading control stick this command will have the meaning of “yaw left” change of the heading of the UAV, with the setpoint yaw velocity proportional to the intensity of the force exerted by the user on the point stick module. Conversely, when the user applies horizontal right force on the altitude/heading control stick this command will have the meaning of “yaw right” change of the heading of the UAV, with the setpoint yaw velocity proportional to the intensity of the force exerted by the user on the point stick module. Zero horizontal force applied on the stick will have the meaning of “hold current heading”. Any combination of commands, e.g. left and up, or down and right, etc. will be supported.

In some embodiments, the UAV controller 10 may contain additional user interface modules or devices. For example, as illustrated in FIGS. 1-6, in an embodiment, the controller 10 may include a plurality of light emitting diodes, including a first LED 24 and a second LED 26 positioned above the left point stick module 20, and a third LED 28 and a fourth LED 30 positioned above the right point stick module 20. In an embodiment, the first LED 24 indicates the connection status of the controller device 10 to the smart device 22, the second LED 26 indicates the connection status of the UAV to the smart device 22 via WiFi/LTE/4G/3G/2G/GPRS, etc., the third LED 28 indicates the connection status of the UAV to the smart device 22 via Bluetooth Low Energy, and the fourth LED 30 indicates the health status of the UAV. Other configurations or layouts are also possible without departing from the broader aspects of the present invention.

As best illustrated in FIG. 2, buttons, including first and second buttons 32, 34 may also be positioned above the left point stick module 20. In an embodiment, the first button 32, when depressed while the UAV is in the air, will issue the command “Execute automated Landing” and when depressed while the UAV is landed will issue the command “Execute automated Take off.” The second button 34, when depressed, will issue the command “Return to Takeoff point.”

As shown in FIGS. 3-5, in an embodiment, the controller 10 may further include a switch 36 positioned on the rear side of the left arm. The switch is configured to activate/deactivate the control of the UAV by the two point stick modules 20. When activated, the controller 10 continuously streams commands issued by the user via the two point stick modules 20. When not activated, a user's forces applied to the point stick modules 20 will not be forwarded to the UAV.

In connection with the above, the UAV controller 10 is configured to communicate with a specially designed mobile application installed on the smartphone or tablet 22 by means of Bluetooth Classic/Bluetooth Low Energy or other wireless connection protocol, or a wired connection to a port of the smartphone/tablet. In an embodiment, the Bluetooth Low Energy communication module contains a CPU and a built-in transceiver, for example, of the type PSoC 4XXX, marketed by Cypress Semiconductor. In an embodiment, the software application is configured to connect and maintain a data connection between the UAV and the tablet/smart device 22 using WiFi and/or the cellular data link of the smart device 22, to connect and maintain a Bluetooth Low Energy connection between the smart device 22 and the controller device 10, to forward commands received from the controller device buttons/switches/point sticks to the UAV for execution, and to update the status LEDs of the controller device 10 upon change of the monitored parameters. In addition to the above, firmware, running on the CPU/MPU of the controller device 10 continuously scan the buttons/switches/point sticks for changes, connects and maintains a Bluetooth Low Energy connection to the smart device 22, sends any changed states of the buttons/switches/point sticks to the smart device 22, and receives from the smart device updates on the status LEDs and change the state of the LEDs accordingly.

In some embodiments, the UAV controller 10 may or may not contain additional user interface modules or devices, for example, LEDs, buttons/switches, small screens and the like. In certain embodiments, the UAV controller 10 may also include additional modules such as, for example, a battery for enhancing the battery life of the smartphone/tablet, an amplified wireless/cellular link to communicate with the UAV directly, and/or position/altitude sensors (e.g., IMU, GPS).

In the preferred embodiment, as alluded to above, the UAV controller 10 contains a CPU module 40 and embedded software, with wireless communication capabilities—which is at least capable of: reading and interpreting the pointing stick module measurements, reading/managing other UI modules on the UAV controller 10, and communicating with the smartphone/tablet 22 to which it is attached.

Turning now to FIGS. 7-12, a UAV controller 100 according to another embodiment of the present invention is shown. The controller is substantially similar to the controller 10 described above in connection with FIGS. 1-6, where like reference numerals designate like part. The controller 100 contains the same internal components as controller 10, and is configured to operate in a substantially similar manner to provide the same functionality. Rather than having a third support arm, however, the controller 100 only has a pair of opposed arms 14, 16 configured to receive the opposed top and bottom edges of a smartphone or tablet therebetween.

As also shown therein, the controller 100 includes opposed finger grip portions 102, 104 below the opposed arms 14, 16. These finger grip portions 102, 104 provide an ergonomic feel to the controller 100 for a user, and ensures that the user is able to securely and comfortably hold the controller while manipulating the point stick modules 20 and any other controls.

Importantly, the controllers disclosed herein are lightweight, ergonomic and present an optimal viewing angle for a user, particularly when the controls are manipulated.

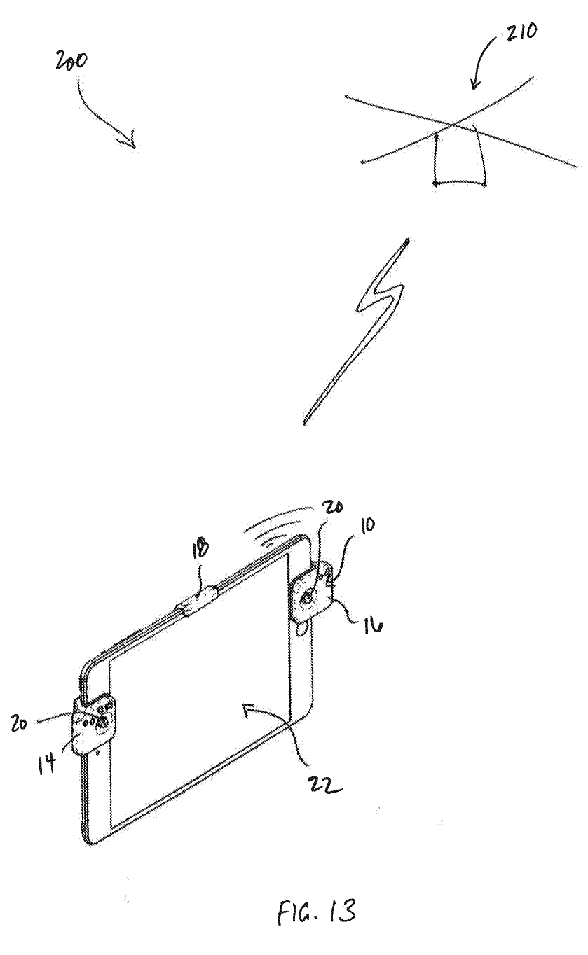

Turning finally to FIG. 13, a system 200 for controlling an unmanned aerial vehicle is shown. The system includes the controller hereinbefore described, e.g., controller 10 or 100, a coupled smart device 22, and an unmanned aerial vehicle 210. As described above, the controller 10 is configured to physically receive the smart device 22 in a manner such that the smart device 22 is attached to the controller 10. In this state, a user or operator can ergonomically grip the controller 10 and smart device 22 while simultaneously viewing the display screen of the smart device 22.

As discussed above, once the switch 36 is actuated, the controller 10 is operable to control movement of the unmanned aerial vehicle 210 through actuation of the respective point stick modules/devices 20. In particular, in operation, a software application running on the smart device 22 is configured to connect and maintain a first data connection between the UAV 210 and the smart device 22 using, for example, WiFi and/or the cellular data link of the smart device 22, and to connect and maintain a second data connection (e.g., a Bluetooth Low Energy connection) between the smart device 22 and the controller 10. When an operator manipulates the point stick devices 20 and/or buttons 32, 34, these actions are translated into commands that are then sent to the smart device 22 over the second data connection. The smart device 22 then controls the UAV 210 in dependence upon the received commands, according to a control algorithm stored in memory and/or according to a software application running on the smart device 22.

While the controller of the present invention has been described above in connection with unmanned aerial vehicles, it is contemplated that the controlled may be utilized to control other devices and machinery, more generally. In addition, in certain embodiments, the controller of the present invention may be utilized in conjunction with video games and the like, such as games on any electronic device with which the controller can be paired, including smartphones, tablets and laptops.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A controller for an unmanned aerial vehicle, comprising:
a frame having a pair of opposed arms configured to removably receive a smart device therebetween;
at least one point stick module positioned on at least one of the arms; and
a control unit configured to establish and maintain a connection with the smart device; and
wherein the at least one point stick module is operable by a user to control movement of the unmanned aerial vehicle.

2. The controller of claim 1, wherein:
the at least one point stick module is a pair of point stick modules positioned on the opposed arms, respectively.

3. The controller of claim 1, further comprising:
a third arm configured to receive another edge the personal electronic device.

4. The controller of claim 1, wherein:
the smart device is one of a smartphone, a tablet and a laptop computer.

5. The controller of claim 1, wherein:
a distance between the pair of opposed arms is variable.

6. The controller of claim 1, further comprising:
at least one light emitting diode indicating at least one of a connection status of the controller to the smart device, a connection status of the unmanned aerial vehicle to the smart device, and a health status of the unmanned aerial vehicle.

7. The controller of claim 1, wherein:
the connection is a Bluetooth Low Energy connection.

8. The controller of claim 1, further comprising:
a first button configured to initiate an automated landing and takeoff of the unmanned aerial vehicle.

9. The controller of claim 8, further comprising:
a second button configured to initiate a flight operation whereby the unmanned aerial vehicle returns to a takeoff point.

10. The controller of claim 1, wherein:
the frame includes a pair of opposed finger grip areas positioned below the opposed arms, respectively.

11. A method for controlling an unmanned aerial vehicle, comprising the steps of:
establishing a first data connection between an unmanned aerial vehicle and a smart device;
establishing a second data connection between the smart device and a controller device;
receiving a plurality of commands from a user interface of the controller device; and
forwarding the plurality of commands from the user interface to the unmanned aerial vehicle for execution.

12. The method according to claim 11, wherein:
the user interface includes at least a first point stick device and a second point stick device;
wherein the first point stick device is configured to control an attitude of the unmanned aerial vehicle; and
wherein the second point stick device is configured to control a heading and altitude of the unmanned aerial vehicle.

13. The method according to claim 11, wherein:
the second data connection is a Bluetooth Low Energy connection.

14. The method according to claim 13, wherein:
the first data connection is one of a cellular and WiFi connection.

15. The method according to claim 11, further comprising the step of:
coupling the smart device to the controller device.

16. The method according to claim 15, wherein:
the smart device is one of a smartphone, a tablet and a laptop computer.

17. A system for controlling an unmanned aerial vehicle, comprising:
a smart device;
a controller having a frame having and a pair of opposed arms defining a receiving space therebetween, and at least one point stick module positioned on at least one of the arms, the receiving space being configured to receive the smart device therein; and
an unmanned aerial vehicle;
wherein the smart device is configured to establish and maintain a first data connection between the unmanned aerial vehicle and a smart device;
wherein the controller is configured to establish and maintain a second data connection between the smart device and a controller; and
wherein the smart device is configured to forward commands from the point stick modules to the unmanned aerial vehicle for execution.

18. The system of claim 17, wherein:
the smart device is one of a smartphone, a tablet and a laptop computer.

19. The system of claim 17, wherein:
a width of the receiving space is variable.

20. The system of claim 17, wherein:
the controller includes a plurality of light emitting diodes indicating a connection status of the controller to the smart device, a connection status of the unmanned aerial vehicle to the smart device, and a health status of the unmanned aerial vehicle.
